(19) United States
(12) Patent Application Publication
(10) Pub. No.: US 2014/0353119 A1
(43) Pub. Date: Dec. 4, 2014

(54) PAPER BOARD STACKING MECHANISM

(71) Applicant: KUAN-SHIUNG WU, YANGMEI TOWNSHIP (TW)

(72) Inventor: KUAN-SHIUNG WU, YANGMEI TOWNSHIP (TW)

(21) Appl. No.: 14/164,256

(22) Filed: Jan. 27, 2014

(30) Foreign Application Priority Data
May 31, 2013 (TW) 102210176

(51) Int. Cl. B65G 57/112

(52) U.S. Cl. CPC B65G 57/112
USPC 198/431

(57) ABSTRACT

A paper board stacking mechanism includes a transfer platform, a front conveyor group, a rear conveyor group, an inclination device, an elevation platform, and a stop plate. The transfer platform receives and conveys cut paper boards rearward. The front conveyor group includes first and second belt conveyors. The first belt conveyor is connected to the transfer platform. The second belt conveyor is connected to the rear end of the first belt conveyor. The rear conveyor group includes third and fourth belt conveyors. The paper boards pass through the front conveyor group and the rear conveyor group to then form at least a paper board stack. The rear end of the fourth belt conveyor maintains a fixed height difference from a surface of the elevation platform on which no paper board stack is loaded or from a top end of a paper board stack positioned on the elevation platform.

### (a) TECHNICAL FIELD OF THE INVENTION

The present invention generally relates to a paper board stacking machine, and more particularly to a paper board stacking machine that performs a stacking operation according to the setting of the number of boards to be stacked.

### (b) DESCRIPTION OF THE PRIOR ART

Most of the conventional corrugated boards are manufactured by first shaping a core and then bonding ridges of the core to surface paper sheet by means of adhesives, and subjecting to cutting to form a desired size. Finally, human labor is used to collect for subsequent boxed and packaged. Such a flow and counting and stacking of the boards of each package require a lot of human labor and time. This has been a drawback that the industry attempts to overcome.

Taiwan Utility Model M336948 that was filed on Dec. 26, 2007 by the present inventor and discloses a “paper board stacking mechanism” for overcoming the above discussed automation issue, wherein a multi-stage conveyor is used to convey cut corrugated boards in such a way that different speeds and different altitudes established among the stages of conveyor allow a plurality of paper boards to be alternately stacked, in a predetermined amount, to form a paper board stack. As such, subsequent packaging and shipping can be made easy, to save human labor and reduce cost.

However, in the last step of being placed on a stacking table of the previously described known device, the paper boards are placed on the stacking table through natural falling due to the height difference between the conveyor and the stacking table. Such an operation may easily lead to random spreading of the paper boards on the stacking table and requiring re-organization. On the other hand, if the conveyor is arranged to match the height of the stacking table, then the conveyor would be set at an inclination of an excessive angle, making it easy for the paper board stacks to shift during the conveyance thereof and eventually leading to random spreading of the paper boards.

### SUMMARY OF THE INVENTION

In view of the above problems, the present invention aims to provide an improvement that make the conveyance of the paper board stacks smooth and thus overcoming the problem of random spreading.

The present invention provides a paper board stacking mechanism, which is used to convey cut paper boards and comprises a transfer platform, a front conveyor group, a rear conveyor group, an inclination device, an elevation platform and a stop plate. The transfer platform receives the cut paper boards and conveys the paper boards to move rearwards.

The front conveyor group comprises a first belt conveyor and a second belt conveyor. The first belt conveyor is connected to the transfer platform and the first belt conveyor is arranged to show an inclined configuration having a rear end higher than a front end; the second belt conveyor is connected to the rear end of the first belt conveyor and the second belt conveyor is arranged in an inclined configuration having a rear end higher than a front end thereof and having a conveyance speed that is slower than a conveyance speed of the first belt conveyor. The rear conveyor group comprises a third belt conveyor and a fourth belt conveyor. The third belt conveyor is arranged at the rear end of the second belt conveyor and the fourth belt conveyor is connected to a rear end of the third belt conveyor and has a conveyance speed faster than a conveyance speed of the third belt conveyor. The paper boards pass through the front conveyor group and the rear conveyor group to then form at least a paper board stack.

The inclination device is connected to the third belt conveyor and the fourth belt conveyor to control angles of inclination of the third belt conveyor and the fourth belt conveyor. The elevation platform is adjacent to a rear end of the fourth belt conveyor and comprises an elevation mechanism to allow the elevation platform to perform an elevating movement. The stop plate is arranged above the elevation platform and is movable frontward/rearward or upward/downward with respect to the elevation platform. The rear end of the fourth belt conveyor maintains a fixed height difference with respect to a surface of the elevation platform that receives no paper board stack thereon or maintains a fixed height difference with respect to a top end of paper board stack positioned on the elevation platform and the elevation platform, during receiving a paper board stack loaded thereon, gradually lowers down until the elevation platform reaches a lowest position.

As such, a stacking-completed paper board stack can be smoothed forward to the elevation platform without causing any problem of random spreading.

Preferably, the elevation platform further comprises a front-rear moving mechanism, which comprises a driver and a rail set, wherein the driver is coupled to the elevation platform and the rail set is arranged below the elevation platform so that the elevation platform is driven by the driver to move along the rail set. As such, adjusting the spacing distance between the elevation platform and the fourth belt conveyor allows the paper board stacks to be arranged in an alternate manner.

Alternatively, the fourth belt conveyor is further coupled to a movable carrier, a pulley set, and a board discharge roller set. The movable carrier is mounted to the rear end of the fourth belt conveyor and is movable frontward/rearward. The pulley set receives a conveyance belt of the fourth belt conveyor to wrap thereon and comprises a front fixed pulley, a rear fixed pulley, a first pulley, and a second pulley. The front fixed pulley and the rear fixed pulley are respectively set at front and rear ends and are fixed in positions thereof and are spaced by a fixed distance. The first pulley is mounted to the movable carrier. The second pulley is mounted to the movable carrier and is movable frontward/rearward with respect to the movable carrier. The board discharge roller set is mounted to the movable carrier and is adjacent to the first pulley. When the movable carrier moves frontward or rearward, the second pulley changes position correspondingly in order to adjust the path that the conveyance belt wraps.

Preferably, the inclination device further comprises a first elevation device, which is connected to a front end of the third belt conveyor and a second elevation device, which is connected to the rear end of the fourth belt conveyor. As such, the control of the angles of inclination can be made more precisely.

Preferably, the first elevation device comprises a first elevation driving device and a first toothed wheel mechanism. The first elevation driving device is connected to the first toothed wheel mechanism to supply power for operation of the first toothed wheel mechanism. The first toothed wheel mechanism comprises a first synchronization shaft, which is connected to a first left toothed wheel set and a right left toothed wheel set. The first left toothed wheel set is coupled, via a chain, to one side of the third belt conveyor. The first right toothed wheel is coupled, via another chain, to an opposite side of the third belt conveyor. The second elevation device comprises a second elevation driving device and a second toothed wheel mechanism. The second elevation driving device is connected to the second toothed wheel mechanism to supply power for operation of the second toothed wheel mechanism. The second toothed wheel mechanism comprises a second synchronization shaft, which is connected to a second left toothed wheel set and a second right toothed wheel set. The second left toothed wheel set is coupled, via a chain, to one side of the fourth belt conveyor. The second right toothed wheel set is coupled, via another chain, to an opposite side of the fourth belt conveyor. As such, the control of angle can be made better and the conveyor is made more stable.

Preferably, the elevation mechanism further comprises four rails, a toothed wheel assembly, and a driving device. The rails are arranged outside the elevation platform. The toothed wheel assembly is coupled to the rails and is connected by chains to the elevation platform. The driving device is connected to the toothed wheel assembly.

Preferably, the front-rear moving mechanism comprises a driver and a rail set, wherein the driver is coupled to the elevation platform and the rail set is arranged below the elevation platform to allow the elevation platform to be driven by the driver to move along the rail set.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic perspective view of an embodiment of the present invention.

FIGS. 2-4 are schematic views illustrating an operation of the embodiment of the present invention.

FIG. 5 is a top plan view of an elevation platform of the embodiment of the present invention.

FIG. 6 is a side elevational view of the elevation platform of the embodiment of the present invention.

FIG. 7 is a schematic view, taken from a different direction, of the elevation platform of the embodiment of the present invention.

FIGS. 8-10 are schematic views illustrating an operation of a stop plate of the embodiment of the present invention.

FIG. 11 is a schematic view showing a first elevation device of the embodiment of the present invention.

FIG. 12 is a schematic view showing a second elevation device of the embodiment of the present invention.

FIGS. 13 and 14 are side elevational views showing an alternative fourth belt conveyor of the embodiment of the present invention.

FIG. 15 is a top plan view of the fourth belt conveyor of FIG. 13.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

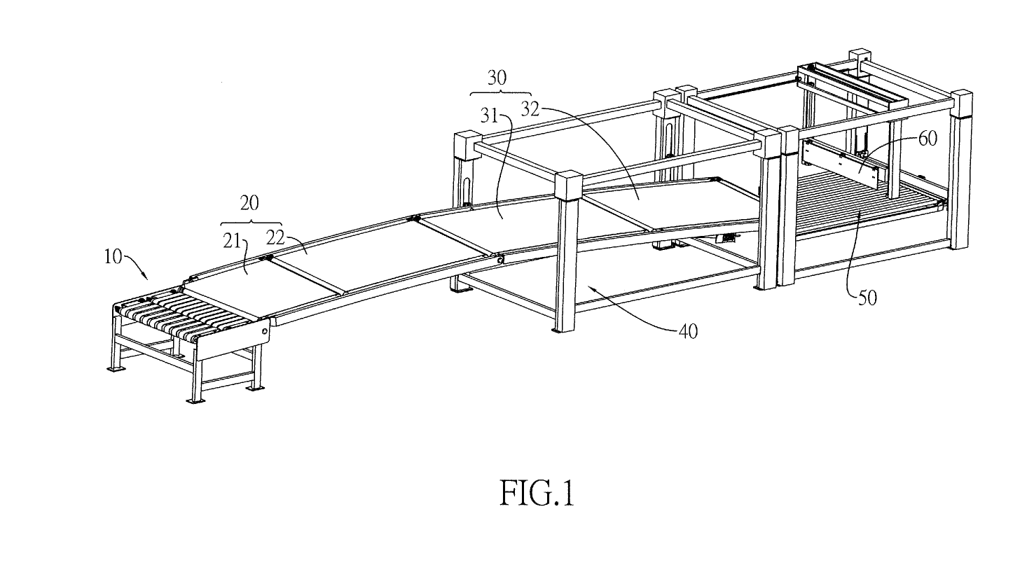

Referring to a schematic perspective view of an instant embodiment shown in FIG. 1.

A paper board stacking mechanism according to the instant embodiment is provided for conveying cut paper boards and comprises a transfer platform 10, a front conveyor group 20, a rear conveyor group 30, an inclination device 40, an elevation platform 50, and a stop plate 60.

The transfer platform 10 receives the paper boards that have been cut and conveys the paper boards to move toward the front conveyor group 20.

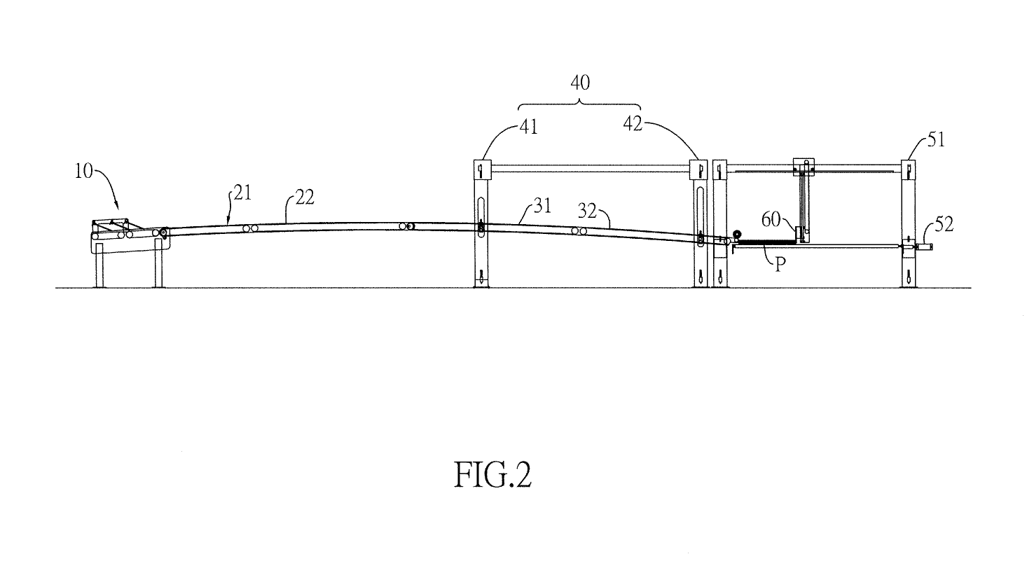

Referring to FIG. 2, the front conveyor group 20 comprises a first belt conveyor 21 and a second belt conveyor 22. The first belt conveyor 21 is connected to the transfer platform 10 and the first belt conveyor 21 is arranged in an inclined configuration having a rear end higher than a front end thereof. The second belt conveyor 22 is connected to the rear end of the first belt conveyor 21 and the second belt conveyor 22 is arranged in an inclined configuration having a rear end higher than a front end thereof and has a conveyance speed that is slower than that of the first belt conveyor 21.

The rear conveyor group 30 comprises a third belt conveyor 31 and a fourth belt conveyor 32. The third belt conveyor 31 is arranged at the rear end of the second belt conveyor 22 and the fourth belt conveyor 32 is connected to the rear end of the third belt conveyor 31 and has a conveyance speed faster than the conveyance speed of the third belt conveyor 31. The paper boards, after passing through the front conveyor group 20 and the rear conveyor group 30, forms at least a paper board stack P.

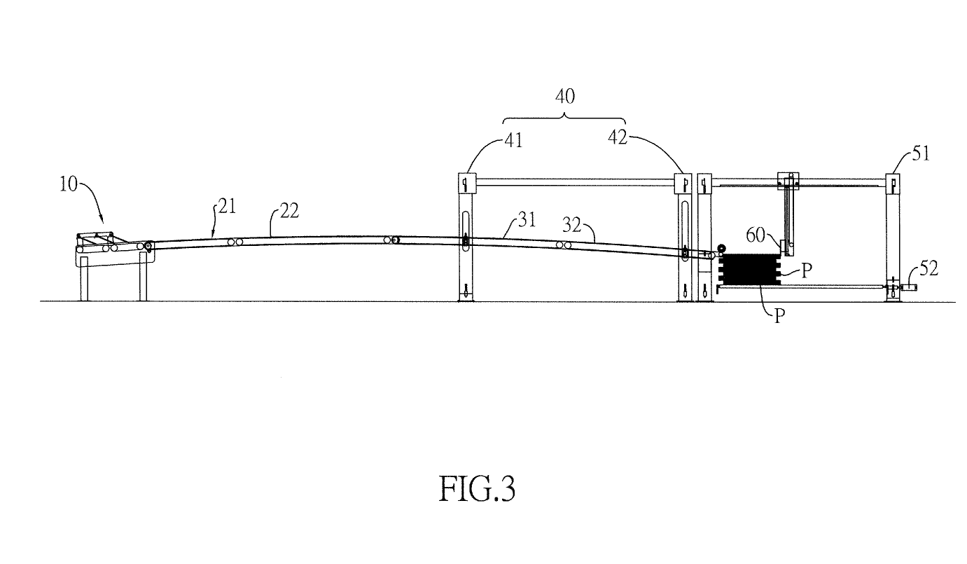

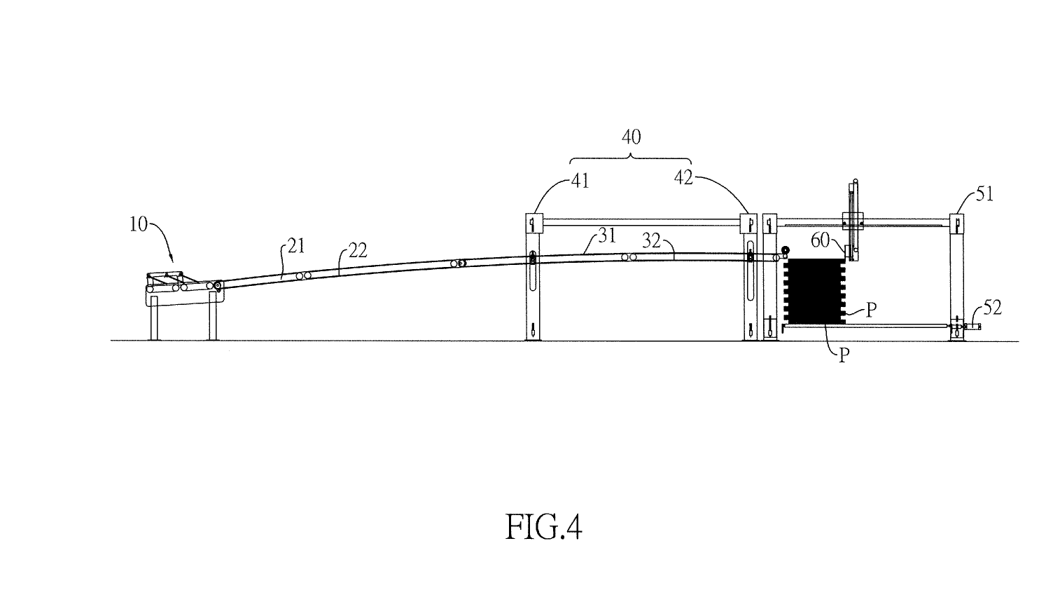

As shown in FIGS. 2-4, the inclination device 40 is connected to the third belt conveyor 31 and the fourth belt conveyor 32 to control angles of inclination of the third belt conveyor 31 and the fourth belt conveyor 32. The inclination device 40 comprises a first elevation device 41 and a second elevation device 42. The first elevation device 41 is connected to a front end the third belt conveyor 31 and the second elevation device 42 is connected to a rear end of the fourth belt conveyor 32. The first elevation device 41 and the second elevation device 42 control extent of inclination of the rear conveyor group 30 and the location of the rear end of the second elevation device 42. The first elevation device 41 and the second elevation device 42 are known and only one of feasible mechanism thereof will be described, but not limited thereto.

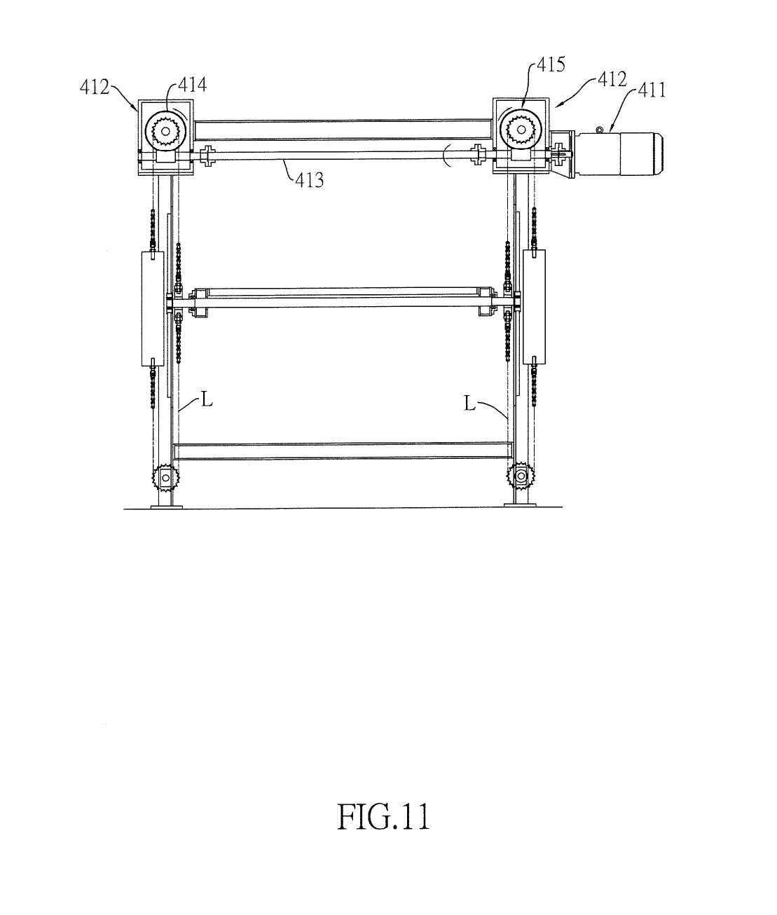

FIG. 11 shows one feasible first elevation device. The first elevation device 41 comprises a first elevation driving device 411 and a first toothed wheel mechanism 412. The first elevation driving device 411 is connected to the first toothed wheel mechanism 412 for supplying power for the operation of the first toothed wheel mechanism 412. A first synchronization shaft 413 connects a first left toothed wheel set 414 and a right left toothed wheel set 415. The first left toothed wheel set 414 is coupled, via a chain, to one side of the third belt conveyor 31 and the first right toothed wheel set 415 is also coupled, via another chain, to an opposite side of the third belt conveyor 31 in order to control a height-wise position of the front end of the third belt conveyor 31 for facilitating subsequent arranging and conveying.

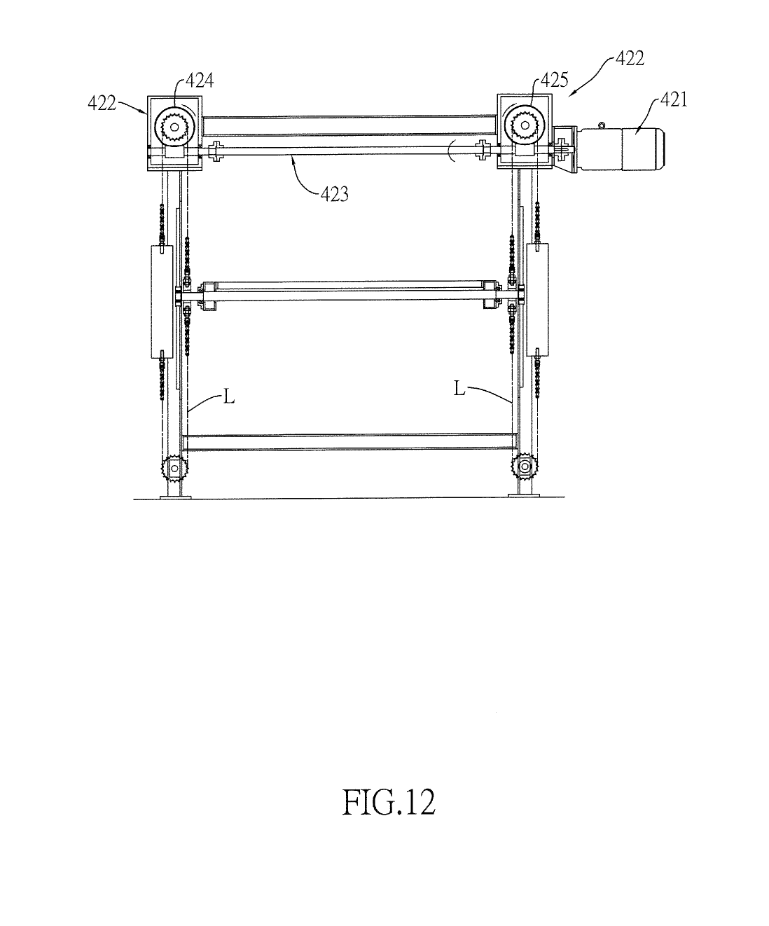

Referring to FIG. 12, the second elevation device 42 comprises a second elevation driving device 421 and a second toothed wheel mechanism 422. The second elevation driving device 421 is connected to the second toothed wheel mechanism 422 for supplying power for the operation of the second toothed wheel mechanism 422. The second toothed wheel mechanism 422 comprises a second synchronization shaft 423 that connects a second left toothed wheel set 424 and a second right toothed wheel set 425. The second left toothed wheel set 424 is coupled, via a chain L, to one side of the fourth belt conveyor 32 and the second right toothed wheel 425 is also coupled, via another chain L, to an opposite side of the fourth belt conveyor 32 so as to control the height of the fourth belt conveyor 32.

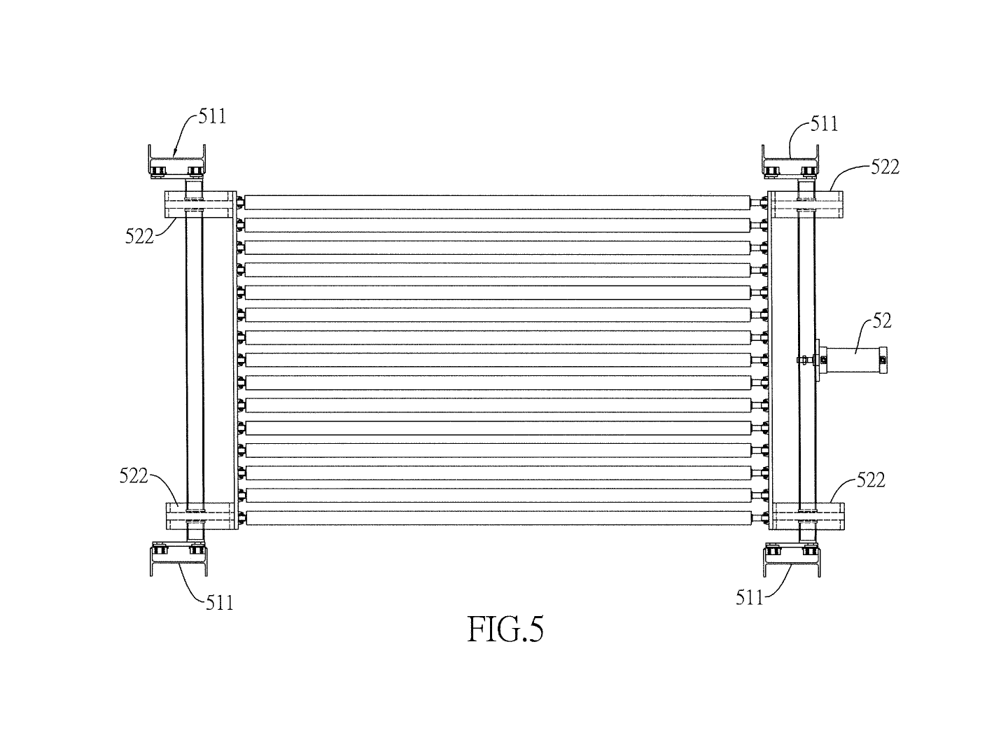

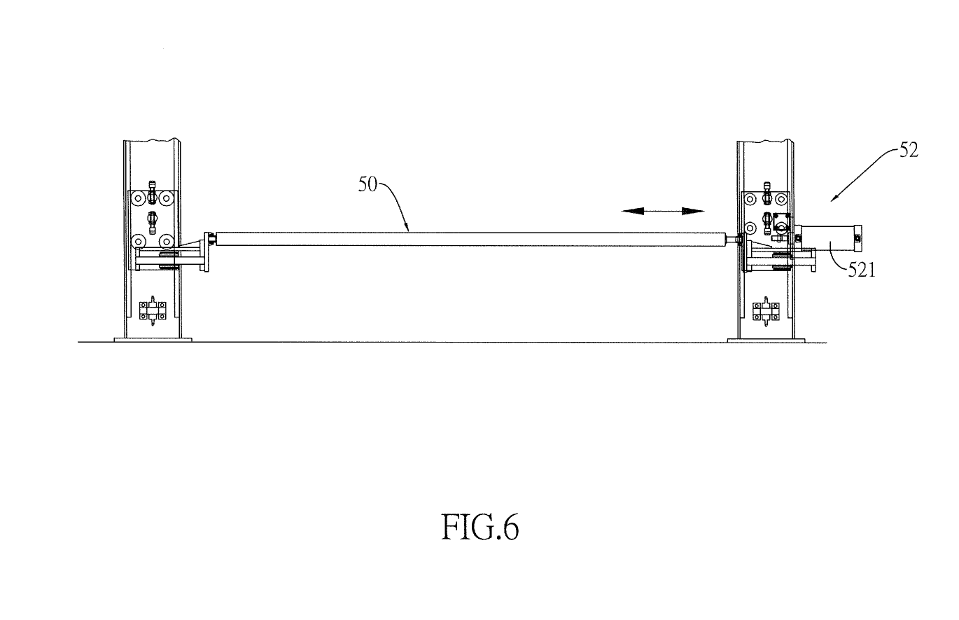

As shown in FIGS. 5 and 6, the elevation platform 50 is adjacent to the rear end of the fourth belt conveyor 32 and is coupled to an elevation mechanism 51 and a front-rear moving mechanism 52 to allow the elevation platform 50 to perform elevation and frontward/rearward movement.

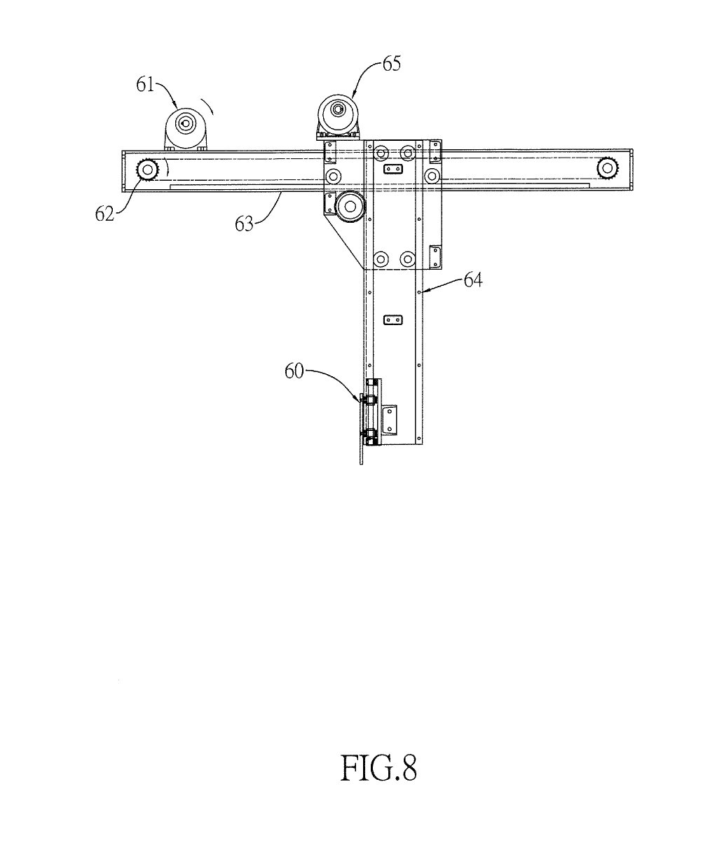

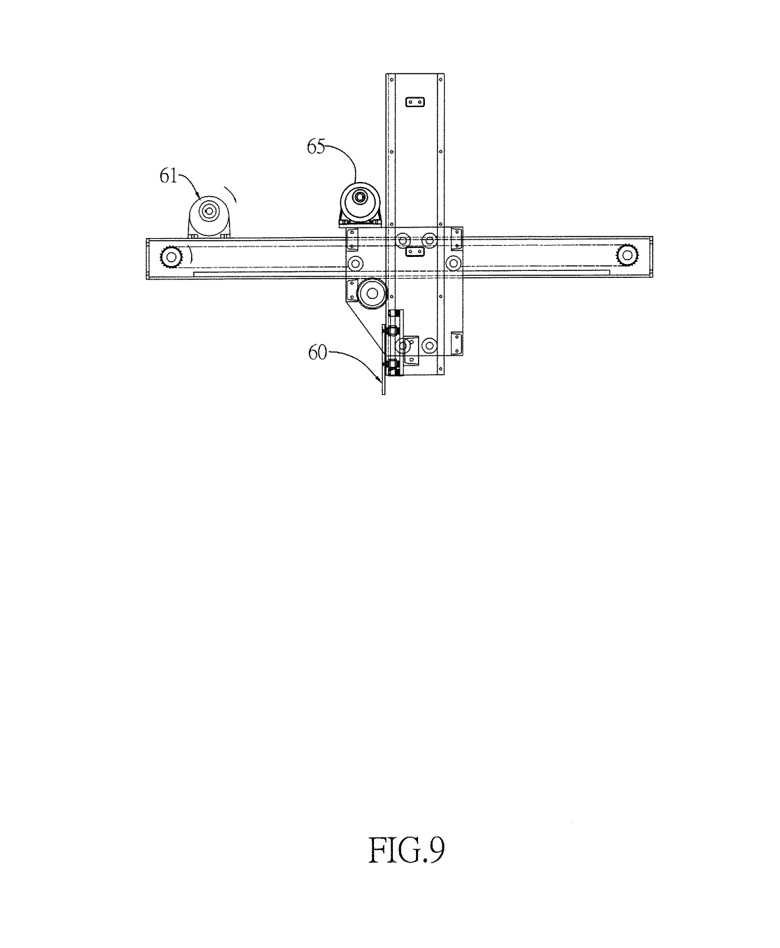

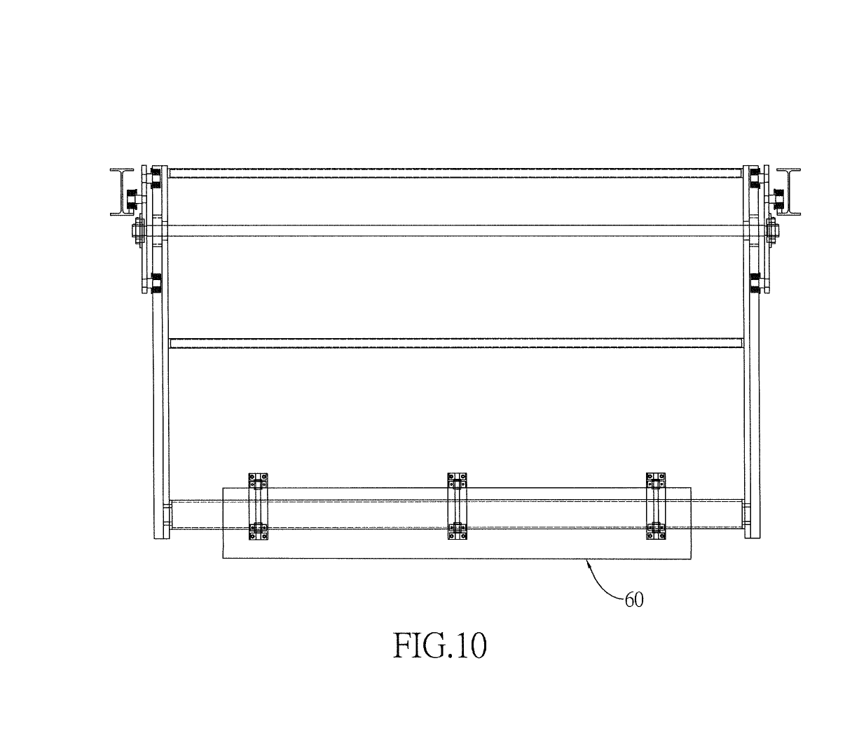

As shown in FIGS. 2-4 and FIGS. 8-10, the stop plate 60 is arranged above the elevation platform 50 and is movable frontward/rearward or upward/downward with respect to the elevation platform 50 to facilitate arranging and stacking the paper board blocks. The paper boards, when discharged from the rear conveyor group 30, are subjected to assistance of the stop plate 60 to be arranged orderly. Particularly, the stop plate 60 follows the variation of the height of the paper board stack P to be maintained at the topmost location of one side of the paper board stack P and with position adjustability of the stop plate 60, the paper board stack P can be arranged in an alternate manner according to a predetermined amount of discharged boards to facilitate subsequent arrangement performed manually.

Referring to FIGS. 2-4, in the instant embodiment, the rear end of the fourth belt conveyor 32 is maintained at a fixed height difference with respect to the surface of the elevation platform 50 that has not received a paper board stack P loaded or is maintained at a fixed height difference with respect to a top end of a paper board stack P positioned on the elevation platform 50. Further, during the loading of the paper board stack P, the elevation platform 50 gradually lowers down until the elevation platform 50 reaches a lowest position, and then the fourth belt conveyor 32 is gradually raised to match the top end of the paper board stack. With the structure of the present invention, the paper board stack P can be stably and gradually stacked upward without causing falling and random spreading of the paper boards during the process of stacking. Further, the height difference employable in the instant embodiment includes the height difference being zero, namely being at the same altitude.

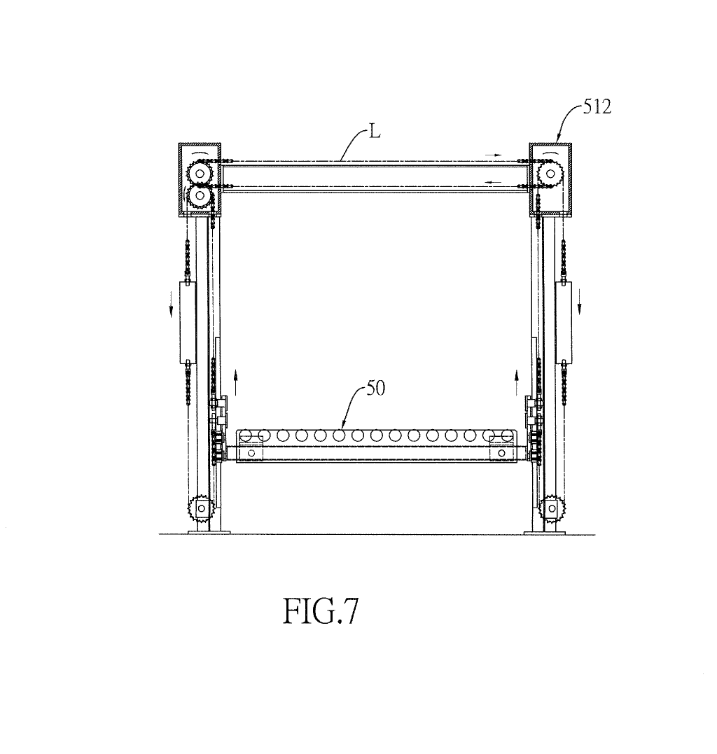

Further, as shown in FIGS. 5-7, the elevation mechanism 51 comprises four rails 511, a toothed wheel assembly 512, and a driving device (not shown). The rails 511 are arranged outside the elevation platform 50 and the toothed wheel assembly 512 is coupled to the rails 511 and is connected via chains to the elevation platform 50. The driving device is connected to the toothed wheel assembly 512. As such, an operation of elevation can be achieved.

The front-rear moving mechanism 52 comprises a driver 521 and a rail set 522, wherein the driver 521 is coupled to the elevation platform 50 and the rail set 522 is arranged below the elevation platform 50 so that the elevation platform 50 can be driven by the driver 521 to move along the rail set 522. The driver 521 can be a pneumatic cylinder, a hydraulic cylinder, or a motor.

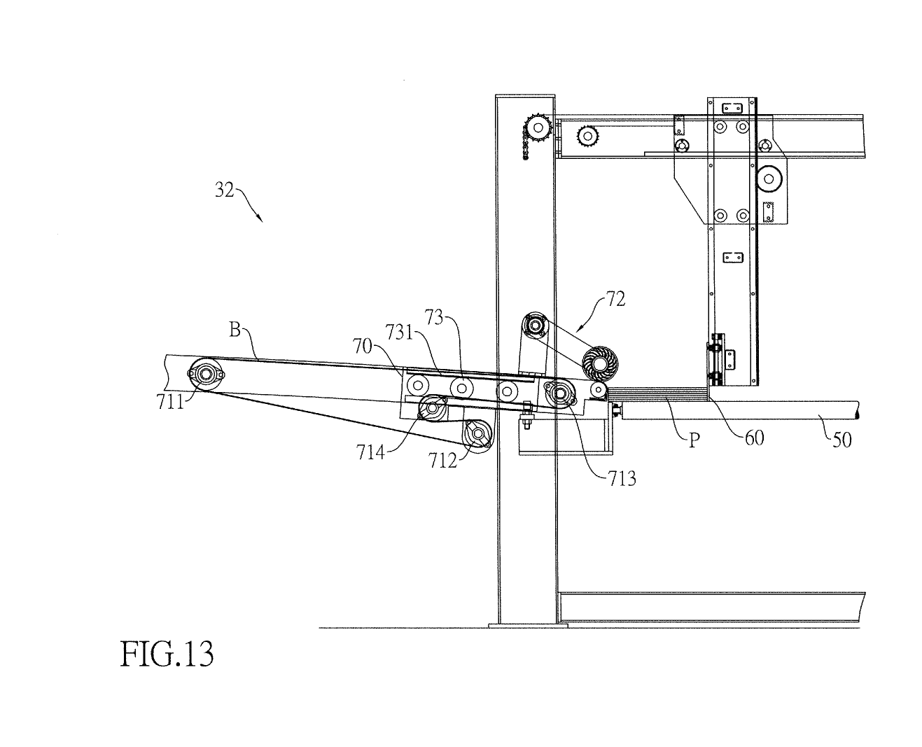

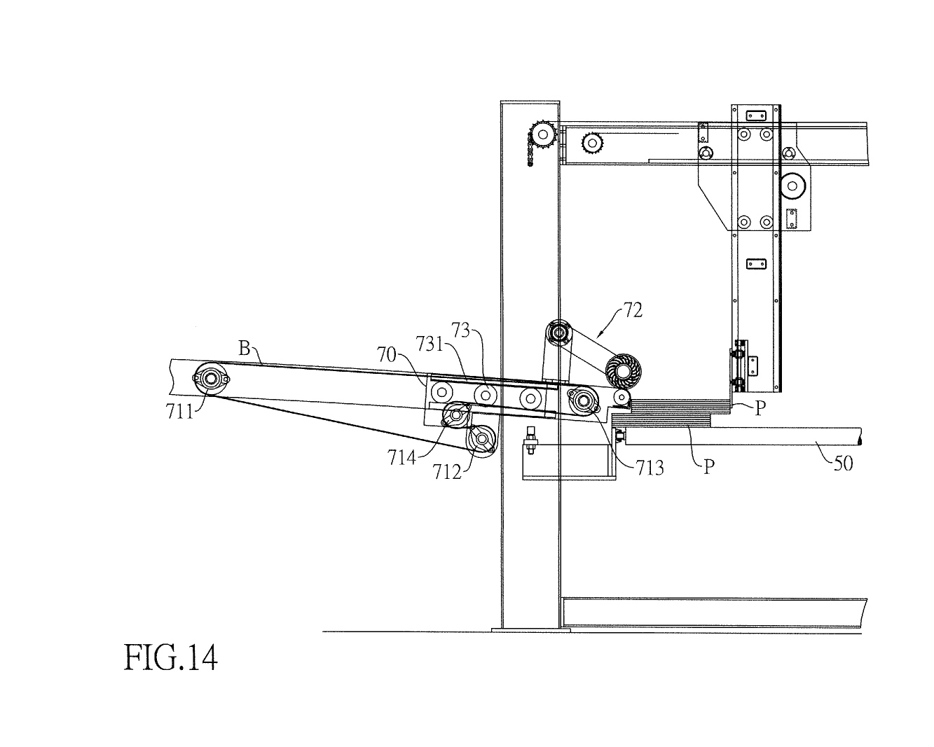

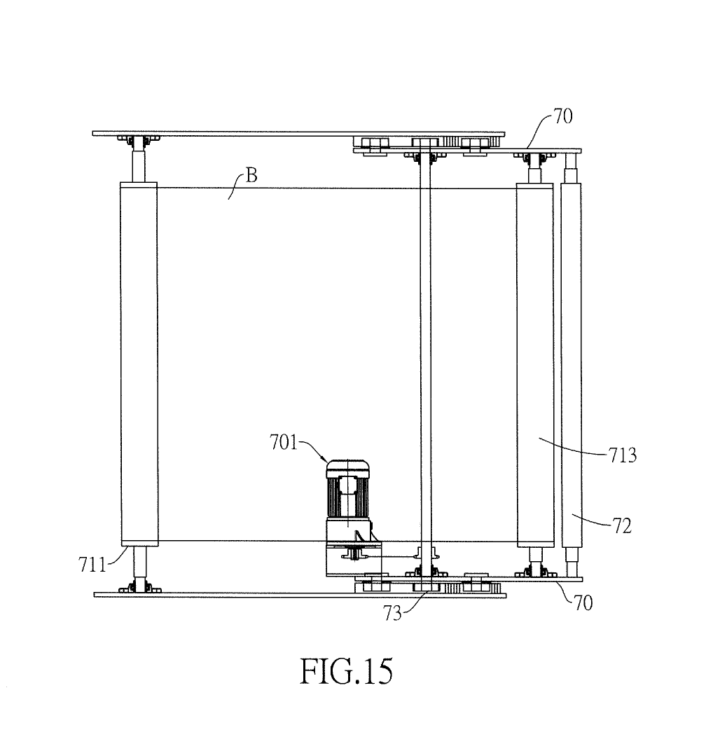

Further, as shown in FIGS. 13-15, to allow paper board stack P to be stacked in an alternate manner, besides the elevation platform 50 in combination with the front-rear moving mechanism 52 as described in the previously discussed embodiment, the mechanism shown in FIGS. 13-15 can be coupled to the fourth belt conveyor 32 to control the position of the fourth belt conveyor 32 so as to achieve the same purposes. The structure comprises a movable carrier 70, a pulley set 71, and a board discharge roller set 72.

The movable carrier 70 is mounted to the rear end of the fourth belt conveyor 32 and is movable frontward/rearward with respect to the elevation platform 50.

The pulley set 71 receives a conveyance belt B of the fourth belt conveyor 32 to wrap thereon and comprises a front fixed pulley 711, a rear fixed pulley 712, a first pulley 713, and a second pulley 714. The front fixed pulley 711 and the rear fixed pulley 712 are respectively set at front and rear ends and have fixed positions. The first pulley 713 is mounted on the movable carrier 70 and the second pulley 714 is mounted on the movable carrier 70. The board discharge roller set 72 is mounted to the movable carrier 70 and is adjacent to the first pulley 713. When the movable carrier 70 moves frontward/rearward, the operation of the pulley set 71 keeps a starting end of the conveyance belt B invariable but a tailing end moves with the movable carrier 70 so as to adjust the conveyance belt B to have the conveyance belt B maintained in a condition of continuously conveying the paper board stack P by following the location of the movable carrier 70.

The location of the movable carrier 70 is moved, in the surface of the drawing sheet, from left-hand side to the right-hand side. The board discharge roller set 72 of the movable carrier 70 and the stop plate 60 is spaced by a spacing distance that is kept fixed after being set to match the size of paper boards, whereby the stop plate 60 is movable in the same direction and by the distance as those of the movable carrier 70 to have the paper boards stacked and arranged according to predetermined location. The paper board stack P, when discharged, is subjected to the assistance of the stop plate 60 to orderly and neatly stacked on the elevation platform 50. After a predetermined number of paper boards or a predetermined height is reached, the movable carrier 70 and the stop plate 60 are moved toward the right-hand side of the drawing sheet to allow the subsequently discharged paper board stack to alternate with respect to the previously discharged paper board stack P. Then, leftward movement is made for returning to facilitate subsequent packaging operation. It is certain that the elevation platform 50 will follow the operation described above to gradually lower down to maintain a fixed height difference with respect to the paper board stack P on the fourth belt conveyor 32 until it reaches the lowest position, and afterwards, the height of the fourth belt conveyor 32 is subsequently changed to maintain the height difference.

Further, the movement of the movable carrier 70 is driven by a driving device 701 and a driving pinion 73 is used to drive a toothed rack 731 mounted on the movable carrier 70 and mating therewith to control the frontward/rearward movement of the movable carrier 70. This is one of a variety of feasible ways and the present invention is not limited to such an arrangement.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A paper board stacking mechanism, adapted to convey cut paper boards, comprising:
a transfer platform, which is adapted to receive the cut paper boards and convey the paper boards to move rearwards;
a front conveyor group, which comprises:
a first belt conveyor, which is connected to the transfer platform, the first belt conveyor being arranged to show an inclined configuration having a rear end higher than a front end, and
a second belt conveyor, which is connected to the rear end of the first belt conveyor, the second belt conveyor being arranged in an inclined configuration having a rear end higher than a front end thereof and having a conveyance speed that is slower than a conveyance speed of the first belt conveyor;
a rear conveyor group, comprising:
a third belt conveyor, which is arranged at the rear end of the second belt conveyor, and
a fourth belt conveyor, which is connected to a rear end of the third belt conveyor and has a conveyance speed faster than a conveyance speed of the third belt conveyor;
the paper boards passing through the front conveyor group and the rear conveyor group to then form at least a paper board stack;
an inclination device, which is connected to the third belt conveyor and the fourth belt conveyor to control angles of inclination of the third belt conveyor and the fourth belt conveyor;
an elevation platform, which is adjacent to a rear end of the fourth belt conveyor and is coupled to an elevation mechanism to allow the elevation platform to perform an elevating movement; and
a stop plate, which is arranged above the elevation platform and is movable frontward/rearward or upward/downward with respect to the elevation platform;
wherein the rear end of the fourth belt conveyor maintains a fixed height difference with respect to a surface of the elevation platform that receives no paper board stack thereon or maintains a fixed height difference with respect to a top end of paper board stack positioned on the elevation platform and the elevation platform, during receiving a paper board stack loaded thereon, gradually lowers down until the elevation platform reaches a lowest position.

2. The paper board stacking mechanism according to claim 1, wherein the elevation platform further comprises a front-rear moving mechanism, which comprises a driver and a rail set, wherein the driver is coupled to the elevation platform and the rail set is arranged below the elevation platform so that the elevation platform is driven by the driver to move along the rail set.

3. The paper board stacking mechanism according to claim 1, wherein the fourth belt conveyor is further coupled to:
a movable carrier, which is mounted to the rear end of the fourth belt conveyor and is movable frontward/rearward;
a pulley set, which receives a conveyance belt of the fourth belt conveyor to wrap thereon and comprises:
a front fixed pulley and a rear fixed pulley, which are respectively set at front and rear ends and are fixed in positions thereof,
a first pulley, which is mounted to the movable carrier, and
a second pulley, which is mounted to the movable carrier; and
a board discharge roller set, which is mounted to the movable carrier and is adjacent to the first pulley.

4. The paper board stacking mechanism according to claim 2, wherein the inclination device further comprises:
a first elevation device, which is connected to a front end of the third belt conveyor; and
a second elevation device, which is connected to the rear end of the fourth belt conveyor.

5. The paper board stacking mechanism according to claim 4, wherein:
the first elevation device comprises a first elevation driving device and a first toothed wheel mechanism, the first elevation driving device being connected to the first toothed wheel mechanism to supply power for operation of the first toothed wheel mechanism; and
the first toothed wheel mechanism comprises:
a first synchronization shaft, which is connected to a first left toothed wheel set and a right left toothed wheel set,
the first left toothed wheel set being coupled, via a chain to one side of the third belt conveyor and the first right toothed wheel set is coupled, via another chain, to an opposite side of the third belt conveyor;
the second elevation device comprises a second elevation driving device and a second toothed wheel mechanism, the second elevation driving device being connected to the second toothed wheel mechanism to supply power for operation of the second toothed wheel mechanism; and
the second toothed wheel mechanism comprises:
a second synchronization shaft, which is connected to a second left toothed wheel set and a second right toothed wheel set,
the second left toothed wheel set being coupled, via a chain, to one side of the fourth belt conveyor and the second right toothed wheel set being coupled, via another chain, to an opposite side of the fourth belt conveyor.

6. The paper board stacking mechanism according to claim 5, wherein the elevation mechanism further comprises:
four rails, which are arranged outside the elevation platform;
a toothed wheel assembly, which is coupled to the rails and is connected by chains to the elevation platform; and
a driving device, which is connected to the toothed wheel assembly.

7. The paper board stacking mechanism according to claim 3, wherein the inclination device further comprises:
a first elevation device, which is connected to a front end of the third belt conveyor; and
a second elevation device, which is connected to the rear end of the fourth belt conveyor.

8. The paper board stacking mechanism according to claim 7, wherein:
the first elevation device comprises a first elevation driving device and a first toothed wheel mechanism, the first elevation driving device being connected to the first toothed wheel mechanism to supply power for operation of the first toothed wheel mechanism; and
the first toothed wheel mechanism comprises:
a first synchronization shaft, which is connected to a first left toothed wheel set and a right left toothed wheel set,
the first left toothed wheel set being coupled, via a chain to one side of the third belt conveyor and the first right toothed wheel set is coupled, via another chain, to an opposite side of the third belt conveyor;
the second elevation device comprises a second elevation driving device and a second toothed wheel mechanism, the second elevation driving device being connected to the second toothed wheel mechanism to supply power for operation of the second toothed wheel mechanism; and
the second toothed wheel mechanism comprises:
a second synchronization shaft, which is connected to a second left toothed wheel set and a second right toothed wheel set,
the second left toothed wheel set being coupled, via a chain, to one side of the fourth belt conveyor and the second right toothed wheel set being coupled, via another chain, to an opposite side of the fourth belt conveyor.

9. The paper board stacking mechanism according to claim 8, wherein the elevation mechanism further comprises:
four rails, which are arranged outside the elevation platform;
a toothed wheel assembly, which is coupled to the rails and is connected by chains to the elevation platform; and
a driving device, which is connected to the toothed wheel assembly.
